(19) United States
(12) Patent Application Publication
(10) Pub. No.: US 2014/0215254 A1
(43) Pub. Date: Jul. 31, 2014

(54) POWER OVER ETHERNET MANAGEMENT ON A NETWORK SWITCH

(71) Applicant: HEWLETT-PACKARD DEVELOPMENT COMPANY, L.P., Houston, TX (US)

(72) Inventors: Raja Sekhar Mandava, Singapore (SG); Scott B. Mains, Roseville, CA (US)

(73) Assignee: Hewlett-Packard Development Company, L.P., Houston, TX (US)

(21) Appl. No.: 13/755,084

(22) Filed: Jan. 31, 2013

(51) Int. Cl. G06F 11/30; G06F 1/26

(52) U.S. Cl. CPC G06F 11/3058; G06F 1/26
USPC 713/340; 713/300

(57) ABSTRACT

Systems, methods, and machine-readable and executable instructions are provided for power over Ethernet (PoE) management on a network switch. PoE management can include monitoring, with a power management unit on the network switch, an amount of available power and monitoring a load associated with each of a plurality of physical network ports via a plurality of physical power over Ethernet (PoE) controllers that each control a respective subset of the plurality of physical network ports. PoE management can include distributing power to the plurality of PoE controllers with the power management unit based on the monitored amount of available power and the monitored loads independently of a correspondence between the plurality of physical network ports and the plurality of PoE controllers.

### BACKGROUND

Power over Ethernet (PoE) technology may include providing electrical power and/or data over Ethernet cabling. Power can be provided in common mode over two or more of the differential pairs of wires in the Ethernet cabling. Power can be supplied from a source within a PoE equipped network switch (e.g., via an internal and/or external power supply associated with the network switch) and/or injected into the Ethernet cabling with a midspan power supply. PoE can be beneficial for devices that receive the power so that they may not require a separate power supply or power outlet to function.

### BRIEF DESCRIPTION OF THE DRAWINGS

FIG. 1 is a diagram illustrating an example of an environment for power over Ethernet management on a network switch according to the present disclosure.

FIG. 2 is a diagram illustrating an example of power over Ethernet management on a network switch according to the present disclosure.

FIG. 3 is a flow chart illustrating an example of a method for power over Ethernet management on a network switch according to the present disclosure.

FIG. 4 is a diagram illustrating an example of a power over Ethernet enabled network switch according to the present disclosure.

### DETAILED DESCRIPTION

Some previous approaches to managing power distribution for a power over Ethernet (PoE) network switch may have included physical PoE controllers that each controlled a certain number of physical network ports, where the network switch was configured to share power equally among the physical PoE controllers by default. Each physical PoE controller may have included power distribution logic (e.g., machine readable and executable instructions and/or an application specific integrated circuit (ASIC)) that was independent of the other physical PoE controllers. The logic could be integrated with the physical PoE controller, or separate therefrom. Each physical PoE controller could detect loads on physical network ports associated therewith and take action to provide power for the loads. In some instances, the physical PoE controller would only have visibility of the load associated with the physical network ports that it controlled and the amount of power allocated to that physical PoE controller.

When a new load was connected, the physical PoE controller (e.g., via its logic) could check its available power as well as its currently used power. If the difference between the available power and the currently used power was sufficient to provide for the new load, the physical PoE controller would provide power for the new load. However, if insufficient power was allocated to the physical PoE controller, the physical PoE controller could drop and/or deny power to any physical network port having a lower priority level in order to provide power for the new load or deny power to the new load. The physical PoE controller (e.g., via its logic) could then request additional power from the network switch to provide for any load that was denied and/or dropped. Thus, physical network ports could be temporarily power cycled when a new load was connected (e.g., connected to a higher priority port) despite the network switch, as a whole, having enough power for all of the loads. Existing loads could be affected and/or delay in powering new loads could occur even though sufficient power was available to the network switch.

In contrast, according to a number of examples of the present disclosure, systems, methods, and machine-readable and executable instructions are provided for PoE management on a network switch. PoE management can include monitoring, with a power management unit on the network switch, an amount of available power and monitoring a load associated with each of a plurality of physical network ports via a plurality of physical power over Ethernet (PoE) controllers that each control a respective subset of the plurality of physical network ports. PoE management can include distributing power to the plurality of PoE controllers with the power management unit based on the monitored amount of available power and the monitored loads independently of a correspondence between the plurality of physical network ports and the plurality of PoE controllers. Physical PoE controllers can be grouped under control of a logical controller (e.g., within the power management unit) that can monitor the power available to the PoE network switch. That power can be provided to the physical network ports with reduced or no delay and/or without impacting existing PoE loads connected if enough power is available. Monitoring an amount of available power and/or monitoring a number of loads can include having visibility of, observing, determining, polling, sensing, among other examples of monitoring the amount of available power and/or the number of loads. Monitoring can be active (e.g., taking an action to determine), passive (e.g., receiving an indication without causing the reception), or a combination thereof.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

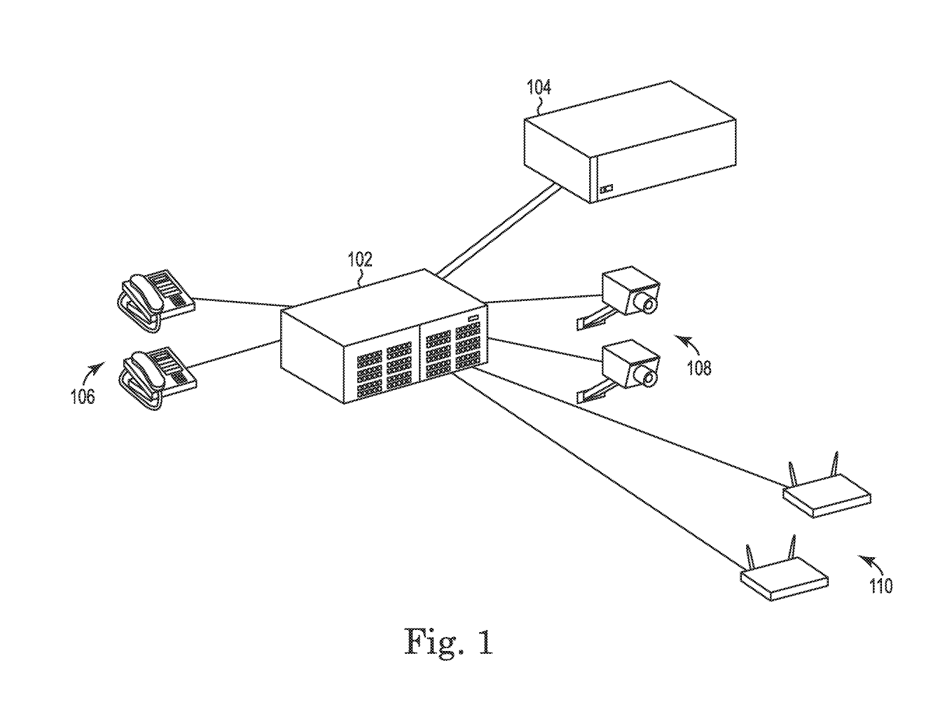

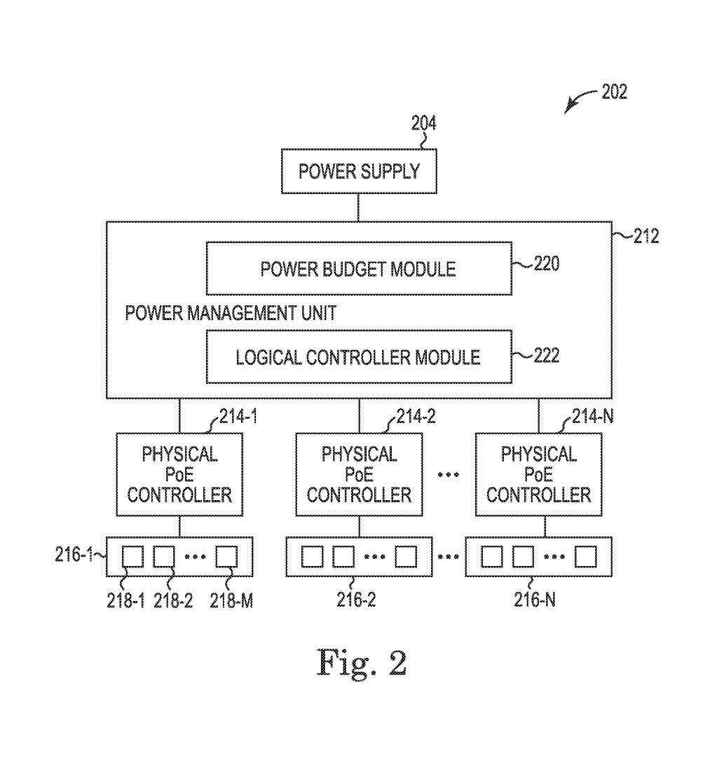

The figures herein follow a numbering convention in which the first digit corresponds to the drawing figure number and the remaining digits identify an element or component in the drawing. For example, reference numeral 102 may identify element “02” in FIG. 1, while an analogous element may be identified by reference numeral 202 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1 is a diagram illustrating an example of an environment for power over Ethernet management on a network switch 102 according to the present disclosure. The PoE network switch 102 is illustrated with connections to an external power supply 104, a number of Internet protocol (IP) telephones 106, a number of security cameras 108, and a number of wireless access points 110 to provide some examples of various devices that may participate in a PoE network. Devices such as IP telephones 106, security cameras 108, and/or wireless access points 110, among others, may typically be connected to a network switch for data transfer. A PoE network switch, such as network switch 102, in addition to providing for data transfer, can also provide power to the connected devices. Such implementations can be advantageous for simplicity so that the devices do not need separate power supplies or power outlets in order to operate.

The network switch 102 can optionally include an internal power supply and/or can receive additional power from an external power supply 104. Although not specifically illustrated, a power supply (e.g., power supply 104) can be connected between the network switch 102 and any of the devices 106, 108, 110, to provide power to the network directly from the power supply to the devices 106, 108, 110, without being routed through the network switch 102.

The network switch 102 can include a plurality of physical network ports to connect to the devices 106, 108, 110 with Ethernet cabling. Subsets of physical network ports can be associated with physical PoE controllers, which according to the present disclosure, can be passive with respect to some previous approaches. For example, the physical PoE controllers can be polled by a power management unit of the network switch 102 to check for any load connection or disconnection, etc. Although not specifically illustrated in FIG. 1, the network switch 102 can include a power management unit connected to the physical PoE controllers. In some examples, the network switch 102 can be compliant with the IEEE 802.3at (PoE+) standard, however examples are not so limited. Additional detail of the network switch 102 and power management unit is provided below.

FIG. 2 is a diagram illustrating an example of power over Ethernet management on a network switch 202 according to the present disclosure. The network switch 202 can be analogous to the network switch 102 illustrated in FIG. 1. The network switch 202 can include and/or be connected to a power supply 204. The network switch 202 can include a plurality of physical network ports (e.g., physical network ports 218-1; 218-2, . . . , 218-M, referred to generally herein as physical network ports 218). Subsets 216-1, 216-2, . . . , 216-N (referred to generally herein as subsets 216) of the plurality of physical network ports 218 can be coupled to respective physical PoE controllers 214-1, 214-2, . . . , 214-N (referred to generally herein as physical PoE controllers 214).

The power supply 204 and the physical PoE controllers 214 can be coupled to a power management unit 212. The power management unit 212 can include hardware and/or software configured to provide the functionality described herein. For example, the power management unit 212 can include a power budget module 220 and/or a logical controller module 222. The power management unit 212 can be configured to distribute power from the power supply 204 to each of the physical PoE controllers 214 equal to a respective load associated with the respective subset 216 of the physical network ports 218 coupled to each of the physical PoE controllers 214.

The power management unit 212 can be configured to detect an additional load on a particular physical network port (e.g., physical network port 218-1) associated with a particular physical PoE controller (e.g., physical PoE controller 214-1) and distribute additional power to the particular physical PoE controller 214-1 without receiving a request for additional power from the particular physical PoE controller 214-1. The physical PoE controllers 214 can be configured not to request additional power (e.g., from the power management unit 212 and/or any other portion of the switch 202). Such examples remove the responsibility of power management from the physical PoE controllers 214, which do not monitor the power requirements for physical network ports 218, other than the physical network ports 218 in the subset 216 that they manage. Power management responsibility is provided by the power management unit 212, which can monitor the power requirements for more physical network ports 218 as well as the available power from a number of power supplies 204. The power management unit 212 can distribute additional power to a physical PoE controller 214 in response to a new and/or additional load being put on a physical network port 218 associated with the physical PoE controller 214. The power management unit 212 can reduce an amount of power distributed to a physical PoE controller 214 in response to a reduced and/or removed load on a physical network port 218 associated with the physical PoE controller 214.

Some previous approaches may have (at least initially) distributed available power (or a portion thereof) from the power supply to each of the physical PoE controllers evenly such that each physical PoE controller shared an equal power budget. Then, it would be up to the physical PoE controllers to request additional power if the load on their respective subset of physical network ports increased beyond their allocated budget. Furthermore, if a particular physical PoE controller had an allocated power budget that was greater than the load on its respective subset of physical network ports, the physical PoE controller would not release the excess power back to the switch (e.g., unless requested by the switch). However, according to a number of examples of the present disclosure, power may not be pre-allocated to particular physical PoE controllers 214 and the physical PoE controllers 214 are not responsible for making power requests. Rather, the power management unit 212, which has more of a global view of the power requirements of the switch 202 is tasked with power management. The power management unit 212 can allocate and/or deallocate power on-the-fly as is needed and/or efficient for the switch as a whole.

The power management unit 212 can monitor an amount of available power (e.g., from a power supply 204) with a first module (e.g., the power budget module 220). The power management unit 212 can monitor a load associated with each of the physical network ports 218 via the physical PoE controllers 214 with a second module (e.g., the logical controller module 222). The logical controller module 222 can have an interface with the power budget module 220 and the physical PoE controllers 214. In some examples, the power management unit 212 can continually (e.g., in real-time) monitor (e.g., with the logical controller module 222) the load associated with each of the physical network ports 218 and continually distribute (e.g., with the logical controller module 222) power to the physical PoE controllers 214 based on changes (e.g., new, increased, decreased, removed, etc.) in the load associated with each of the physical network ports 218. In some examples, the power management unit 212 can periodically poll the physical PoE controllers 214 to determine a load thereon and/or monitor the load thereon directly at each of the physical network ports 218.

The power management unit 212 can distribute (e.g., via the logical controller module 220) power to a physical PoE controller 214 in response to a newly monitored load and/or an increased load associated with a physical network port 218 coupled to the physical PoE controller 214 in response to an amount of available power being sufficient to handle the newly monitored load (e.g., as determined by the power budget module 220). However, in some instances, sufficient power may not be available to power the new and/or increased load. The physical network ports 218 and/or the physical PoE controllers 214 can have a priority (e.g., high priority, medium priority, low priority) assigned thereto. In some examples, the priority can be assigned to the physical network port 218 and/or the physical PoE controller 214 based on a perceived importance of the devices that are powered via the physical network ports 218. For the instances in which insufficient power is available for a new and/or increased load, a power distribution to a physical network port 218 having a lower priority can be reduced to power a load on a different physical network port 218 having a higher priority (e.g., the power distributed to a first physical PoE controller 214-1 can be reduced in order to provide additional power to a second physical PoE controller 214-2 when a physical network port 218 coupled to the second physical PoE controller 214-2 has a higher priority than a physical network port 218 coupled to the first physical PoE controller 214-1).

The logical controller module 222 can detect a load associated with each physical PoE controller 214 and take necessary action to distribute power for the load. The logical controller module 222 can monitor the total power available to the power budget module 220 as well as the amount of power currently used by each of the physical PoE controllers 214. When a new or increased load is monitored by the logical controller module 222, it can check the power available at the power budget module 220 and the power used by the physical PoE controllers 214. If the power available at the power budget module 220 is sufficient for the new and/or increased load, the logical controller module 222 can distribute the power accordingly. If the power available at the power budget module 220 is insufficient for the new and/or increased load, the logical controller module can request the power budget module 220 to request additional power from the system (e.g., from an additional power supply such as power supply 204). If the power budget module 220 is able to attain additional system power, the logical controller module 222 can distribute that power accordingly. If insufficient power is available and the power budget module 220 is unable to obtain additional power, then the logical controller module 222 can drop and/or deny power to any lower priority physical network port 218. According to some examples of the present disclosure, a physical network port 218 is denied power only if it is unavailable at the system level, as opposed to some previous approaches in which power could be denied at the physical PoE controller level (e.g., if the physical PoE controller did not already have enough power distributed thereto).

Although not specifically illustrated in FIG. 2, some examples of the present disclosure can include a switch 202 that includes multiple power budget modules 220 and logical controller modules 222 and/or a chassis system that includes multiple switches 202. For example, a 24-port 218 switch 202 can include six physical PoE controllers 214 and one power budget module 220 and one logical controller module 222. For example, a 48-port 218 switch 202 can include 12 physical PoE controllers 214 and two power budget modules 220 and two logical controller modules 222. A chassis system can include more physical network ports 218, physical PoE controllers 214, and more power budget modules 220 and logical controller modules 222 (e.g., 12 of each). However, the specific examples given are not limiting in number of components or the relative proportions therebetween.

A system power module can allocate a respective power budget from a number of power supplies 204 to a plurality of power budget modules 220. The plurality of power budget modules 220 can each receive a respective power budget from the system power module and allocate the respective power budget to a respective logical controller module 222 as described herein. The plurality of logical. controller modules 222, each associated with one of the power budget modules 220, can monitor loads and distribute a portion of the respective power budget accordingly. In some examples, each power budget modules 220—logical controller module 222 pair can be associated with a respective slot or rack in the chassis system.

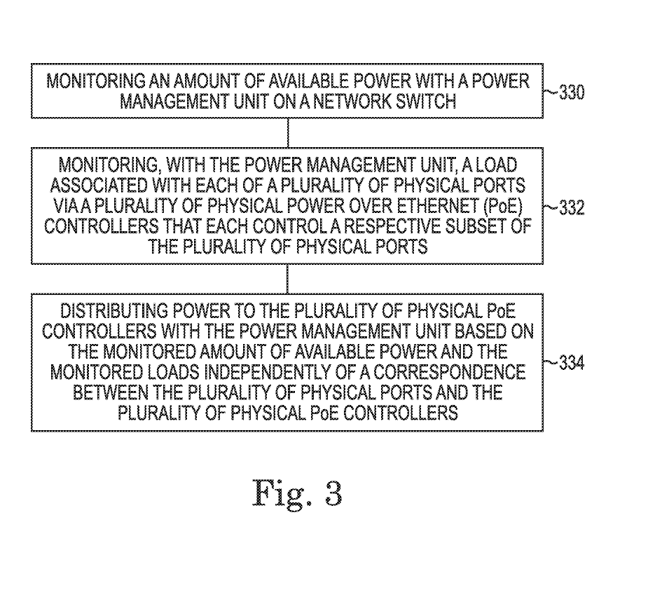

FIG. 3 is a flow chart illustrating an example of a method for power over Ethernet management on a network switch according to the present disclosure. Such a network switch can be analogous to the network switch 202 illustrated in FIG. 2. At block 330, a power management unit (e.g., power management unit 212 illustrated in FIG. 2) can monitor an amount of available power with a power management unit on a network switch. At block 332, the power management unit can monitor a load associated with each of a plurality of physical network ports (e.g., physical network ports 218 illustrated in FIG. 2) via a plurality of physical PoE controllers (e.g., physical PoE controllers 214 illustrated in FIG. 2) that each control a respective subset (e.g., subsets 216 illustrated in FIG. 2) of the plurality of physical network ports.

At block 334, the power management unit can distribute power to the plurality of physical PoE controllers based on the monitored amount of available power and the monitored loads independently of a correspondence between the plurality of physical network ports and the plurality of physical PoE controllers. Distributing power independently of the correspondence between the physical network ports and the physical PoE controllers can include distributing power to each of the physical PoE controllers based on a total load associated with the respective subset of physical ports controlled thereby (e.g., as opposed to dividing power evenly for each physical PoE controller or based on the number of ports controlled by each physical PoE controller). A portion of the available power can be distributed to the physical PoE controllers, where the portion is equal to the monitored load, without distributing a remainder of the available power to any of the physical PoE controllers (e.g., not all of the power is distributed unless the load on the physical network ports requires it). The power can be distributed to the physical PoE controllers without receiving a request therefrom (e.g., because the power management unit can monitor the load on each physical PoE controller and/or each physical network port).

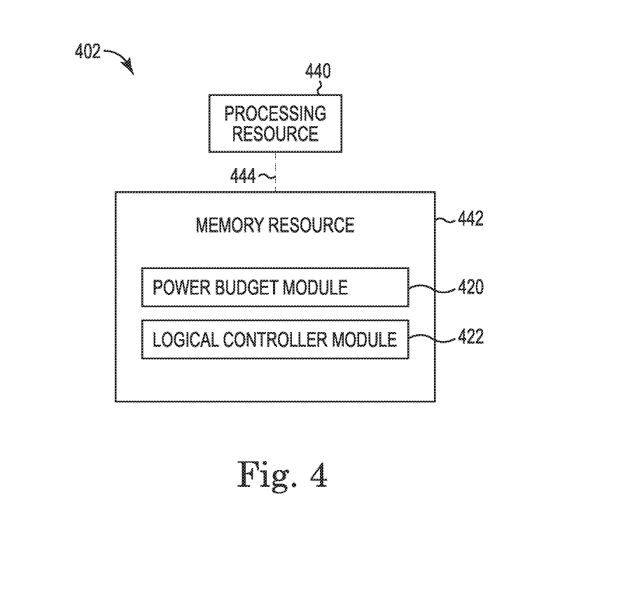

FIG. 4 is a diagram illustrating an example of a power over Ethernet enabled network switch 402 according to the present disclosure. The PoE switch 402 can be analogous to the PoE switch 102 in FIG. 1. The PoE switch 402 can utilize software, hardware, firmware, and/or logic to perform a number of functions. The PoE switch 402 can be a combination of hardware and program instructions configured to perform a number of functions (e.g., actions). The hardware, for example, can include a number of processing resources 440 and a number of memory resources 442, such as a machine-readable medium (MRM) or other memory resources 442. The memory resources can be internal and/or external to the PoE switch 402 (e.g., the PoE switch 402 can include internal memory resources and have access to external memory resources). The program instructions (e.g., machine-readable instructions (MRI)) can include instructions stored on the MRM to implement a particular function (e.g., an action such as managing PoE on a network switch). The set of MRI can be executable by one or more of the processing resources 440. The memory resources 442 can be coupled to the PoE switch 402 in a wired and/or wireless manner. For example, the memory resources 442 can be an internal memory, a portable memory, a portable disk, and/or a memory associated with another resource, e.g., enabling MRI to be transferred and/or executed across a network such as the Internet.

Memory resources 442 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 440 can be coupled to the memory resources 442 via a communication path 444. The communication path 444 can be local or remote to the PoE switch 402. Examples of a local communication path 444 can include an electronic bus internal to a machine, where the memory resources 442 are in communication with the processing resources 440 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 444 can be such that the memory resources 442 are remote from the processing resources 440, such as in a network connection between the memory resources 442 and the processing resources 440. That is, the communication path 444 can be a network connection. Examples of such a network connection can include local area network (LAN), wide area network (WAN), personal area network (PAN), and the Internet, among others.

As shown in FIG. 4, the MRI stored in the memory resources 442 can be segmented into a number of modules 420, 422 that when executed by the processing resources 440 can perform a number of functions. As used herein a module includes a set of instructions included to perform a particular task or action. The number of modules 420, 422 can be sub-modules of other modules. For example, the logical controller module 422 can be a sub-module of the power budget module 420 and/or the logical controller module 422 and the power budget module 420 can be contained within a single module. Furthermore, the number of modules 420, 422 can comprise individual modules separate and distinct from one another. Examples are not limited to the specific modules 420, 422 illustrated in FIG. 4.

The PoE switch 402 can include a power budget module 420, which can be analogous to the power budget module 220 illustrated in FIG. 2. The power budget module 420 can receive a power budget and allocate the power budget to a logical controller module 422. The power budget module 420 can request an addition to the power budget from a system resource (e.g., a power supply) in response to a received request for additional power from the logical controller module 422.

The PoE switch 402 can include a logical controller module 422, which can be analogous to the logical controller module 222 illustrated in FIG. 2. The logical controller module 422 can monitor a load associated with each of a plurality of physical network ports via a plurality of physical PoE controllers that each control a respective subset of the plurality of physical network ports. The logical controller module 422 can distribute a portion of the power budget not exceeding a total monitored load to the plurality of physical PoE controllers. The portion of the power budget can be the entirety of the power budget when the total monitored load is equal to or greater than the entirety of the power budget.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method comprising:
monitoring an amount of available power with a power management unit on a network switch;
monitoring, with the power management unit, a load associated with each of a plurality of physical network ports via a plurality of physical power over Ethernet (PoE) controllers that each control a respective subset of the plurality of physical network ports; and
distributing power to the plurality of physical PoE controllers with the power management unit based on the monitored amount of available power and the monitored loads independently of a correspondence between the plurality of physical network ports and the plurality of physical PoE controllers.

2. The method of claim 1, wherein distributing power independently of the correspondence between the plurality of physical network ports and the plurality of physical PoE controllers comprises distributing power to each of the plurality of physical PoE controllers based on a total load associated with the respective subset of physical network ports controlled thereby.

3. The method of claim 1, wherein the distributing power comprises distributing a portion of the available power to the plurality of physical PoE controllers equal to the monitored load without distributing a remainder of the available power to any of the plurality of physical PoE controllers.

4. The method of claim 1, wherein distributing power comprises distributing power without receiving a request from the plurality of physical PoE controllers.

5. The method of claim 1, wherein:
monitoring the amount of power available comprises monitoring the amount of power available to a first module of the network switch;
monitoring the load comprises monitoring the load with a second module on the network switch that has an interface with the first module and the plurality of physical PoE controllers; and
wherein the method includes allocating, with the first module, the amount of power available to the second module for distribution to the plurality of physical PoE controllers.

6. The method of claim 5, wherein:
monitoring the load comprises continually monitoring the load associated with each of the plurality of physical network ports with the second module; and
distributing power comprises continually distributing power to the plurality of physical PoE controllers with the second module based on changes in the load associated with each of the plurality of physical network ports.

7. The method of claim 1, wherein distributing power comprises distributing power to a particular physical PoE controller based on a newly monitored load associated with a particular physical network port coupled to the particular physical PoE controller in response to the amount of available power being sufficient to handle the newly monitored load.

8. The method of claim 7, wherein the method includes reducing a power distribution to one of the plurality of physical network ports having a lower priority than the particular port in response to the amount of available power being insufficient to handle the newly monitored load.

9. A non-transitory machine-readable medium storing instructions executable by a machine for power over Ethernet (PoE) management on a network switch, comprising:
a power budget module to receive a power budget and allocate the power budget to a logical controller module; and
the logical controller module to:
monitor a load associated with each of a plurality of physical network ports via a plurality of physical power over Ethernet (PoE) controllers that each control a respective subset of the plurality of physical network ports; and
distribute a portion of the power budget not exceeding a total monitored load to the plurality of physical PoE controllers.

10. The medium of claim 9, wherein the instructions comprise the power budget module to request an addition to the power budget from a system resource in response to a received request for additional power from the logical controller module.

11. The medium of claim 9, wherein the portion of the power budget comprises an entirety of the power budget when the total monitored load is equal to or greater than the entirety of the power budget.

12. The medium of claim 9, wherein the instructions comprise:
a system power module to allocate a respective power budget from a number of power supplies to a plurality of power budget modules;
the plurality of power budget modules each to receive the respective power budget and allocate the respective power budget to a respective logical controller module; and
a plurality of logical controller modules, each associated with one of the plurality of power budget modules, to monitor loads and distribute a portion of the respective power budget;
wherein each power budget module—logical controller module pair is associated with a respective slot or rack in a chassis.

13. A network switch, comprising:
a power supply;
a plurality of physical network ports;
a plurality of physical power over Ethernet (PoE) controllers each coupled to a respective subset of the plurality of physical network ports; and
a power management unit coupled to the power supply and to the plurality of physical PoE controllers, wherein the power management unit is configured to distribute power from the power supply to each of the plurality of physical PoE controllers equal to a respective load associated with the respective subset of the plurality of physical network ports coupled to each of the plurality of physical PoE controllers.

14. The switch of claim 13, wherein the plurality of physical PoE controllers are configured not to request additional power.

15. The switch of claim 13, wherein the power management unit is configured to detect an additional load on a particular physical network port associated with a particular physical PoE controller and supply additional power to the particular physical PoE controller without receiving a request for additional power from the particular physical PoE controller.
